(19) United States
(12) Patent Application Publication
(10) Pub. No.: US 2004/0173322 A1
(43) Pub. Date: Sep. 9, 2004

(54) Apparatus for removing an adhesive film on a chip

(76) Inventors: Pang-Chieh Yen, Hsinchu Hsien (TW); Jen-Te Huang, Hsinchu Hsien (TW); Yves Huang, Hsinchu Hsien (TW); Tanja Liu, Hsinchu Hsien (TW)

Correspondence Address: PRO-TECHTOR INTERNATIONAL, 20775 Norada Court, Saratoga, CA, 95070-3018, US

(21) Appl. No.: 10/384,929

(22) Filed: Mar. 5, 2003

(51) Int. Cl. B32B 1/00

(52) U.S. Cl. 156/584

(57) ABSTRACT

An apparatus for removing an adhesive film on a chip that has been cut. The adhesive film is adhered to a bottom surface of the chip. The apparatus includes a sucker, a push-up needle device, and a vacuum chamber. The sucker is arranged above the chip with the adhesive film to suck the chip. The push-up needle device is arranged under the bottom surface of the chip and has a slim support surface to support the adhesive film on the bottom surface of the chip. The vacuum chamber is arranged below the bottom surface of the chip to suck the adhesive film downward and separate the adhesive film from the chip. Accordingly, it is possible to prevent the chip 38 from being broken or cracked owing to the uneven force.

### BACKGROUND OF THE INVENTION

1. Field of the Invention

The invention relates to an apparatus for removing an adhesive film on a chip, and in particular to an apparatus for removing the adhesive film on a slim chip by evenly applying a force on the chip. The apparatus may prevent the chip from broken and is suitable for chips with different sizes.

2. Description of the Related Art

During the semiconductor manufacturing processes, an adhesive film has to be adhered to a backside of a wafer before the wafer formed with wires is to be cut into individual chips. Therefore, during the process for cutting the wafer, the chippings that are removed from the wafer may be adhered to the adhesive film without being scattering. After the cutting process, the chippings may be separated from the adhesive film.

Referring to FIGS. 1 and 2, a conventional apparatus for removing an adhesive film on a chip includes a chip sucker 10, a push-up needle device 16, and a vacuum chamber 20. The chip sucker 10 is arranged above a chip 14 with an adhesive film 12 to suck the chip 14. The push-up needle device 16 includes a plurality of push-up needles 18 distributed, under a bottom surface of the chip 14 to support the chip 14 and pressing the adhesive film 12 against the chip 14. The vacuum chamber 20 is arranged below the bottom surface of the chip 14 to suck the adhesive film 12 downward and separate the adhesive film 12 from the chip 14. The chip 14 after being cut is placed under the sucker 10 and is sucked by the sucker 10. Then, the push-up needles 18 of the push-up needle device 16 support the chip 14. At this time, the vacuum chamber 20 is vacuumed, and the adhesive film 12 on the chip 14 is sucked downward and is separated from the chip 14. Hence, the adhesive film 12 may be removed from the chip 14.

However, the conventional apparatus for removing an adhesive film on a chip has the following drawbacks.

1. When the push-up needles 18 unevenly support the chip 14, the chip 14 may be broken or cracked.

2. When the ratio of the length to the width of the chip 14 is too great, the push-up needles 18 may damage the chip more easily or tilt the chip and the adhesive film 12 cannot be easily removed accordingly.

3. When the sizes of the chips are different, the support positions of the push-up needles 18 and the number of push-up needles 18 have to be adjusted, thereby causing inconvenience in manufacturing processes.

### SUMMARY OF THE INVENTION

An object of the invention is to provide an apparatus for removing an adhesive film on a chip, wherein the apparatus is capable of evenly applying forces on the chip in order to prevent the chip from being damaged.

Another object of the invention is to provide an apparatus for removing an adhesive film on a chip, wherein the adhesive films on the chips with different sizes can be removed without changing the push-up needle device.

To achieve the above-mentioned objects, the invention provides an apparatus for removing an adhesive film on a chip that has been cut. The adhesive film is adhered to a bottom surface of the chip. The apparatus includes a sucker, a push-up needle device, and a vacuum chamber. The sucker is arranged above the chip with the adhesive film to suck the chip. The push-up needle device is arranged under the bottom surface of the chip and has a slim support surface to support the adhesive film on the bottom surface of the chip. The vacuum chamber is arranged below the bottom surface of the chip to suck the adhesive film downward and separate the adhesive film from the chip.

Accordingly, when the push-up needle device utilizes its slim support surface to support the bottom surface of the chip, it is possible to prevent the chip from being broken or cracked owing to the uneven force. It is also possible to remove adhesive films on chips with different sizes without changing the push-up needle device.

### BRIEF DESCRIPTION OF THE DRAWINGS

FIG. 1 is an exploded, pictorial view showing a conventional apparatus for removing an adhesive film on a chip.

FIG. 2 is a cross-sectional view showing the conventional apparatus for removing the adhesive film on the chip.

FIG. 3 is an exploded, pictorial view showing an apparatus for removing an adhesive film on a chip according to an embodiment of the invention.

FIG. 4 is a pictorial view showing the apparatus for removing the adhesive film on the chip of the invention.

FIG. 5 is a cross-sectional view taken along a line 5-5 of FIG. 4.

FIG. 6 is a cross-sectional view taken along a line 6-6 of FIG. 4.

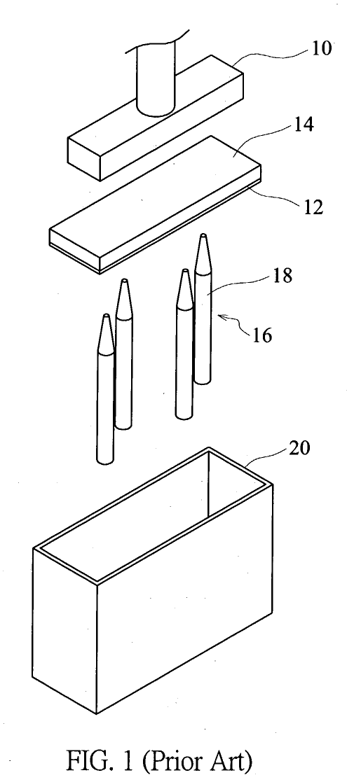

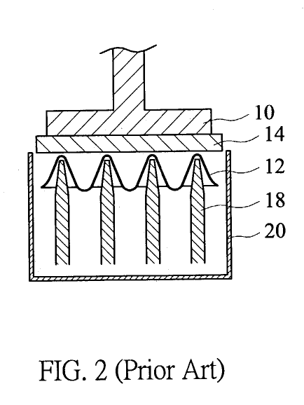

### DETAILED DESCRIPTION OF THE INVENTION

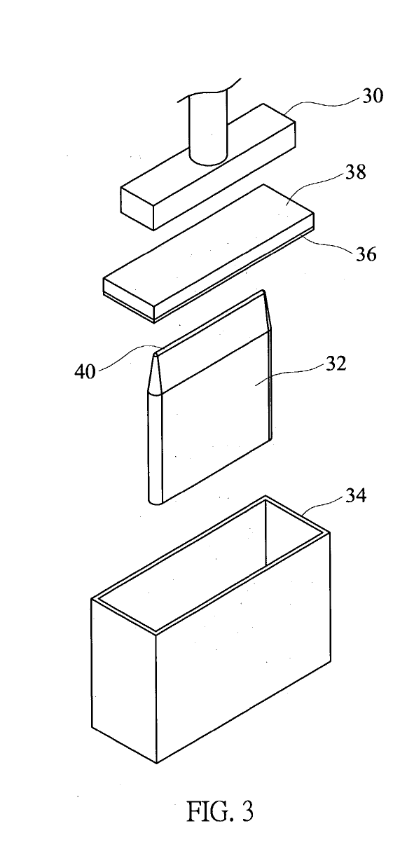

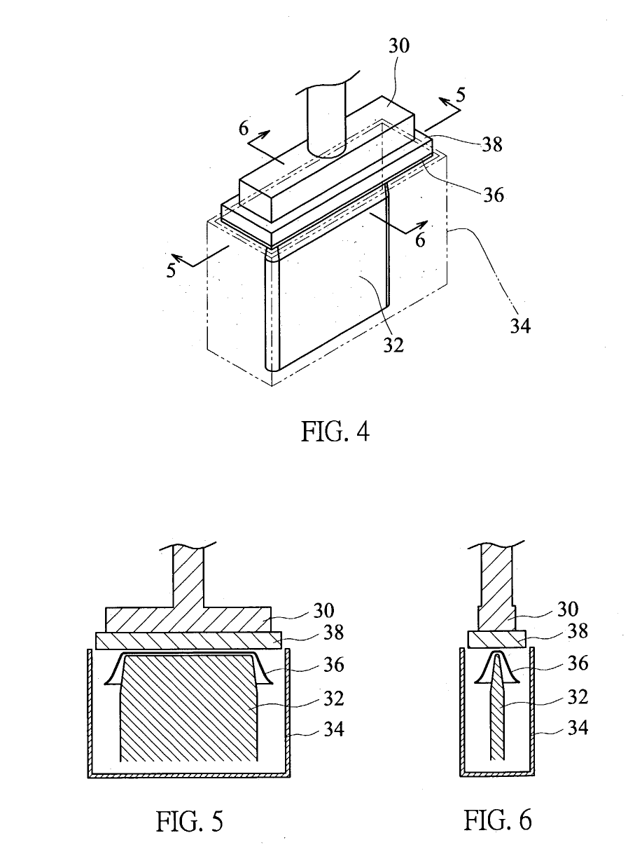

Referring to FIGS. 3 and 4, an apparatus for removing an adhesive film on a chip of the invention includes a sucker 30, a push-up needle device 32 and a vacuum chamber 34.

The sucker 30 is arranged above a chip 38 with an adhesive film 36 to suck the chip 38, which is a slim chip. A ratio of the length to the width of the chip 38 is greater than or equal to 9:1.

The push-up needle device 32, which has a slim support surface 40 to support the adhesive film 36 on a bottom surface of the chip 38, is arranged under the bottom surface of the chip 38.

The vacuum chamber 34 is arranged below the bottom surface of the chip 38 to suck the adhesive film 36 downward. Then, the adhesive film 36 may be easily removed from the chip 38.

Please refer to FIGS. 5 and 6. When the vacuum chamber 34 is vacuumed, the adhesive film 36 on the bottom surface of the chip 38 is sucked downward and may be separated from the chip 38 automatically. Consequently, the chip 38 may be removed from the adhesive film 36. Because the push-up needle device 32 utilizes its slim support surface 40 to support the bottom surface of the chip 38, a uniform force may be applied to the chip 38. Therefore, it is possible to prevent the chip 38 from being broken or cracked. Furthermore, when a lot of chips 38 with different sizes are processed, the same push-up needle device 32 may be conveniently utilized to remove the adhesive films 36 from the chips 38 without changing the push-up needle device 32 and the position of the push-up needle device 32.

While the invention has been described by way of an example and in terms of a preferred embodiment, it is to be understood that the invention is not limited to the disclosed embodiment. To the contrary, it is intended to cover various modifications. Therefore, the scope of the appended claims should be accorded the broadest interpretation so as to encompass all such modifications.

What is claimed is:

1. An apparatus for removing an adhesive film on a chip that has been cut, the adhesive film being adhered to a bottom surface of the chip, the apparatus comprising:
a sucker arranged above the chip with the adhesive film to suck the chip;
a push-up needle device arranged under the bottom surface of the chip and having a slim support surface to support the adhesive film on the bottom surface of the chip; and
a vacuum chamber arranged below the bottom surface of the chip to suck the adhesive film downward and separate the adhesive film from the chip.

2. The apparatus according to claim 1, wherein the chip is a slim chip, and a ratio of a length to a width of the chip is greater than or equal to 9:1.
